(19) United States
(12) Patent Application Publication
(10) Pub. No.: US 2017/0203778 A1
(43) Pub. Date: Jul. 20, 2017

(54) ELECTRIC POWERED UTILITY CARTS

(71) Applicant: Keith JACKSON, Wood River, IL (US)

(72) Inventor: Keith JACKSON, Wood River, IL (US)

(21) Appl. No.: 15/001,508

(22) Filed: Jan. 20, 2016

(51) Int. Cl. B62B 5/00; B62B 3/00

(52) U.S. Cl. CPC B62B 5/0036; B62B 5/0069; B62B 3/008

(57) ABSTRACT

A utility cart includes a cargo platform having a plurality of wheels, a plurality of electric motors coupled to the cargo platform, and a rideable platform configured to support a user. One of the plurality of electric motors corresponds to one of the plurality of wheels. Another one of the plurality of electric motors corresponds to another one of the plurality of wheels. The plurality of electric motors are configured to drive the plurality of wheels. The rideable platform is coupled to the cargo platform and includes at least one wheel. Additional example utility carts each including a cargo platform, a rideable platform and/or other optional features are also disclosed.

### FIELD

The present disclosure relates to electric powered utility carts.

### BACKGROUND

Utility carts are typically used to transport cargo from one location to another. The utility carts may or may not include a motor for moving the carts between different locations. When motorized, the carts commonly include additional motor related components such gears, chains, belts, etc. to transfer mechanical power between the motor and wheels of the carts.

### SUMMARY

This section provides a general summary of the disclosure, and is not a comprehensive disclosure of its full scope or all of its features.

According to one aspect of the present disclosure, a utility cart includes a cargo platform having a plurality of wheels, a plurality of electric motors coupled to the cargo platform, and a rideable platform configured to support a user. One of the plurality of electric motors corresponds to one of the plurality of wheels. Another one of the plurality of electric motors corresponds to another one of the plurality of wheels. The plurality of electric motors are configured to drive the plurality of wheels. The rideable platform is coupled to the cargo platform and includes at least one wheel.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a side view of a utility cart including a cargo platform and a rideable platform coupled to the cargo platform according to one example embodiment of the present disclosure.

FIG. 2 is a top view of the utility cart of FIG. 1.

FIG. 3 is a front view of the utility cart of FIG. 1.

FIG. 4 is a rear view of the utility cart of FIG. 1.

FIG. 5 is a side view of a utility cart without a rideable platform according to another example embodiment.

FIG. 6 is a side view of a utility cart having a foldable cargo platform according to yet another example embodiment.

FIG. 7 is a top view of the utility cart of FIG. 6.

FIG. 8 is a side view of the utility cart of FIG. 6, with the cargo platform in its folded position.

Corresponding reference numerals indicate corresponding parts throughout the several views of the drawings.

### DETAILED DESCRIPTION

### A. Definitions

For purposes of this disclosure, the terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Additionally, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Further, spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

### B. Example Utility Carts

The present disclosure relates to various example utility carts. Each utility cart includes a cargo platform having a plurality of wheels, a plurality of electric motors coupled to the cargo platform, and a rideable platform configured to support a user. One of the plurality of electric motors corresponds to one of the plurality of wheels. Another one of the plurality of electric motors corresponds to another one of the plurality of wheels. The plurality of electric motors are configured to drive the plurality of wheels. The rideable platform is coupled to the cargo platform and includes at least one wheel.

By having at least two electric motors correspond to at least two wheels, the utility cart may have direct drive capabilities. For example, one electric motor can directly drive one wheel while another electric motor can directly drive another wheel. These electric motors may be considered direct drive electric motors. Because the utility cart can include direct drive capabilities, the electric motors of the utility cart can provide mechanical power to the wheels without power reduction components and/or other motor related components. Thus, the utility carts disclosed herein do not require gear(s), belt(s), chain(s), and/or other mechanisms to rotate wheels, reduce power from the electric motors, etc. that are commonly found in other carts. Because less components are required, the utility carts may experience a reduction in noise (e.g., due to less vibration, etc.) as compared to other motorized carts. This may be advantageous depending on, for example, the use of the utility carts as further explained below.

Additionally, the reduction of components may provide reduced costs (e.g., repair, manufacturing, labor, etc.), a longer lifetime, increased power efficiency, etc. for the utility carts as compared to other motorized carts. For example, the power efficiency may be increased because the utility carts disclosed herein do not experience power loss from power reduction and/or other motor related components as compared to other motorized carts.

Further, each electric motor of the utility carts can drive its corresponding wheel independently to allow for substantially zero radius turning of the utility cart. For example, one electric motor may drive its corresponding wheel while another electric motor does not drive its corresponding wheel. In such examples, the utility cart including these electric motors and corresponding wheels may experience substantially zero radius turning. Thus, the utility carts may be able to operate, maneuver, etc. easier than other motorized carts.

The utility carts disclosed herein may be used in various applications including, for example, outdoor activities and/or indoor activities. For example, the utility carts can be used in warehouses, homes, stores (e.g., grocery stores, etc.), wooded areas, hilly areas, and/or other suitable outdoor activities and/or indoor activities. Additionally, the utility carts may be used to transport cargo such as harvested wildlife game, equipment, wood, boxes, individuals, animals, etc. between different locations thereby minimizing stress on a user's body. Thus, a user riding on the rideable platform of the utility carts can effectively maneuver through various different environments without experiencing undesired stress on his/her body.

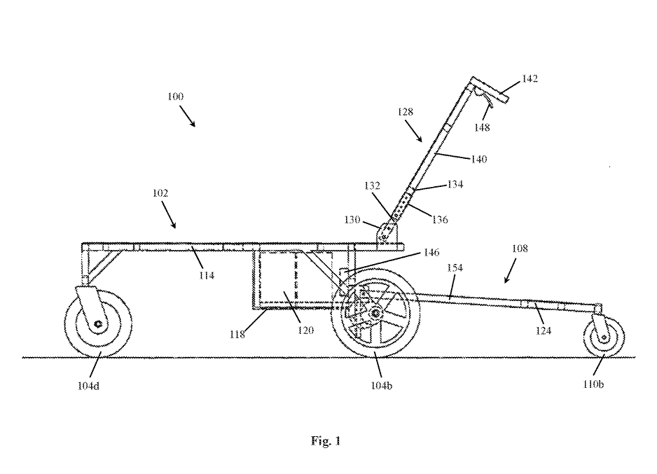

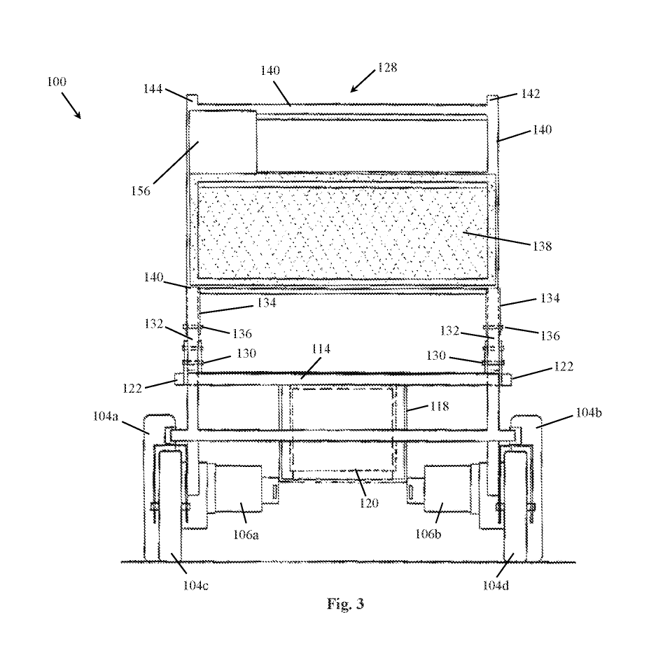

Other utility cart embodiments of the present disclosure, including the specific example embodiments described below and shown in FIGS. 1-8, may include one or more of the various benefits and/or optional features disclosed herein.

For example, and in one embodiment, the rideable platform may be detachably coupled to the cargo platform. In such examples, the rideable platform may be detachably coupled to the cargo platform via one or more mechanical fasteners such as hitches, pins (e.g. lock pins, etc.), screws, nuts, etc. Thus, a user can walk behind the self-propelled utility cart if the rideable platform is detached, ride behind the self-propelled utility cart if the rideable platform is attached, etc. Alternatively, the rideable platform may be permanently coupled to the cargo platform. For example, the rideable platform may be welded to the cargo platform, the rideable platform and the cargo platform may be formed of one piece of material (e.g., monolithic), etc.

In another embodiment, the cargo platform of the utility cart may be a foldable cargo platform. For example, the cargo platform may include two or more portions coupled together via one or more joints (e.g., hinges, hitches, pins, and/or other suitable joints). As such, one portion of the cargo platform can fold onto another portion of the cargo platform. This allows a user to conveniently store, move, etc. the utility cart if desired.

In yet another embodiment, the cargo platform may have at least four wheels. The four wheels may be positioned adjacent different corners of the cargo platform for stability. Alternatively, the cargo platform may include two wheels, three wheels, or more than four wheels. For example, two wheels may be positioned adjacent a central portion of the cargo platform. In other examples, two wheels may be positioned adjacent a rear portion of the cargo platform (e.g., near the rideable platform) and one wheel may be positioned adjacent an opposing front portion of the cargo platform. Still further, one wheel may be positioned adjacent the rear portion of the cargo platform and two wheels may be positioned adjacent the front portion of the cargo platform.

Additionally, the electric motors may correspond to wheels adjacent the rear portion of the cargo platform such that the utility cart is considered a rear wheel drive cart. Alternatively, the electric motors may correspond to wheels adjacent the front portion of the cargo platform such that the utility cart is considered a front wheel drive cart.

In some embodiments, the rideable platform includes two wheels. The wheels may be adjacent opposing edges of the rideable platform. Alternatively, the rideable platform may include one wheel positioned adjacent a central portion of the rideable platform, three wheels, etc.

In other embodiments, the utility cart may include a controller to control the electric motors. For example, the controller may include a control module coupled to the electric motors and one or more user operable inputs in communication with the at least one control module. The user operable inputs may provide one or more signals to the control module. The control module can then provide one or more control signals to at least one of the electric motors for control purposes.

For example, the user operable inputs can control an amount of electric power received by each electric motor. This varying power can change a rotational speed of each electric motor's shaft, turn on/off each electric motor, etc. The changing rotational speed can, for example, move the utility cart forward (e.g., if the speed of each electric motor's shaft is substantially equal), turn the cart, (e.g., if the speed of each electric motor's shaft is not equal), etc. Additionally, and as further explained below, the user operable inputs may change the rotational direction of the electric motor's rotor allowing the utility cart to move forward and/or in reverse.

In some examples, the controller may receive other inputs in addition to or alternative to the user operable inputs. For example, the control module may receive inputs relating to one or more of the wheels (e.g., tire pressure, alignment, etc.), the cargo platform (e.g., weight/pressure of cargo placed on the cargo platform, location of cargo placed on the cargo platform, etc.), the rideable platform (e.g., weight/pressure exerted on the rideable platform to ensure a user is on the platform, etc.), the electric motors (e.g., feedback from the motors, etc.), etc. The control module can use these inputs (if necessary) to control the electric motors as explained above, provide a warning, notification, etc. to a user of the utility cart, etc.

In one embodiment, the utility cart may include at least one battery to provide electric power to the electric motors. For example, the utility cart may include one or more rechargeable batteries and/or single use batteries. The batteries may provide 12 volts, 24 volts, or another suitable voltage. In some embodiments, the batteries may be coupled to the electric motors via one or more electronic components (e.g., converters, etc.) to change and/or regulate the output voltage of the batteries provided to the motors.

Additionally and/or alternatively, the electric motors of the utility cart may be powered by other suitable power sources such as solar panel(s), etc. For example, solar panel(s) may provide power to the electric motors and/or the batteries (if employed) to ensure the batteries are fully charged. Thus, if both solar panel(s) and batteries are employed, the batteries may be considered a backup power source to the solar panel(s).

In some embodiments, the utility cart may include a battery compartment to support the at least one battery. For example, the cargo platform of the utility cart can include a bed to support cargo (as explained above) and a battery compartment coupled to the bottom side of the bed. As such, valuable space on the top side of the bed is not lost.

In some examples, the bed of the cargo platform may include a door for accessing the battery compartment from the top side of the cargo platform. Additionally and/or alternatively, the battery compartment may include a door, opening, etc. to allow a user to access the one or more batteries stored therein.

In other embodiments, the utility cart may include at least one handle bar coupled to the cargo platform. The handle bar may allow a user to effectively maneuver the utility cart throughout various different terrains. The handle bar may be adjustable to accommodate different users utilizing the cart. For example, the handle bar may include one or more mechanisms to adjust a length of the handle bar. The mechanisms may include, for example, a slip-sleeve adjustment mechanism, spring biased protrusions, removable pins, removable portions of the handle bar, etc.

In some embodiments, the handle bar may be foldable. For example, the handle bar may be coupled to the cargo platform via one or more pivotable joints (e.g., hinges, pins, etc.) to allow the handle bar to fold onto the cargo platform. Additionally and/or alternatively, the handle bar may be folded onto itself similar to the cargo platform as explained above.

In one embodiment, the user operable input(s) as explained above are coupled to the handle bar. For example, the user operable input(s) can include one or more actuating levers, buttons, joysticks, and/or other suitable user inputs coupled to one or more portions of the handle bar.

### C. Further Embodiments

### Embodiment 1

A utility cart includes a cargo platform having a plurality of wheels, a plurality of electric motors coupled to the cargo platform, and a rideable platform configured to support a user. One of the plurality of electric motors corresponds to one of the plurality of wheels. Another one of the plurality of electric motors corresponds to another one of the plurality of wheels. The plurality of electric motors are configured to drive the plurality of wheels. The rideable platform is coupled to the cargo platform and includes at least one wheel.

### Embodiment 2

The utility cart of embodiment 1, wherein the rideable platform is detachably coupled to the cargo platform.

### Embodiment 3

The utility cart of embodiment 1 or 2, wherein the cargo platform is a foldable cargo platform.

### Embodiment 4

The utility cart of any one of the previous embodiments, wherein the cargo platform includes a first portion, a second portion, and one or more joints coupled between the first portion and the second portion, the joints configured to allow at least one of the first portion and the second portion to fold onto the other one of the first portion and the second portion.

### Embodiment 5

The utility cart of embodiment 4, wherein the one or more joints include at least one hinge.

### Embodiment 6

The utility cart of any one of the previous embodiments, wherein the at least two wheels of the rideable platform includes two wheels.

### Embodiment 7

The utility cart of any one of the previous embodiments, wherein the at least two wheels of the cargo platform includes four wheels.

### Embodiment 8

The utility cart of any one of the previous embodiments, wherein the plurality of electric motors includes two electric motors.

### Embodiment 9

The utility cart of embodiment 8, wherein the two electric motors each include a direct drive electric motor.

### Embodiment 10

The utility cart of embodiment 8 or 9, wherein each of the two electric motors is configured to drive its corresponding wheel of the plurality of wheels independently to allow for substantially zero radius turning of the utility cart.

### Embodiment 11

The utility cart of any one of the previous embodiments, further comprising at least one handle bar coupled to the cargo platform.

### Embodiment 12

The utility cart of embodiment 11, wherein the at least one handle bar includes a mechanism configured to adjust a length of the at least one handle bar.

### Embodiment 13

The utility cart of embodiment 11 or 12, wherein the at least one handle bar is coupled to the cargo platform via one or more pivotable joints to allow the at least one handle bar to fold onto the cargo platform.

### Embodiment 14

The utility cart of any one of the previous embodiments, further comprising a controller configured to control the plurality of electric motors.

### Embodiment 15

The utility cart of embodiment 14, wherein the controller includes at least one control module coupled to the plurality of electric motors and one or more user operable inputs in communication with the at least one control module.

### Embodiment 16

The utility cart of embodiment 14 or 15, further comprising at least one handle bar coupled to the cargo platform and wherein the one or more user operable inputs are coupled to the at least one handle bar.

### Embodiment 17

The utility cart of embodiment 15 or 16, wherein the one or more user operable inputs includes one or more actuating levers.

### Embodiment 18

The utility cart of any one of embodiments 15-17, wherein the plurality of electric motors are each configured to receive electric power and wherein the one or more user operable inputs are configured to control an amount of electric power received by each of the plurality of electric motors.

### Embodiment 19

The utility cart of any one of the previous embodiments, further comprising at least one battery configured to provide power to the plurality of electric motors.

### Embodiment 20

The utility cart of embodiment 19, wherein the cargo platform includes a bed configured to support cargo and a battery compartment configured to support the at least one battery, wherein the bed includes a top side and a bottom side, and wherein the battery compartment is coupled to the bottom side of the bed.

### Examples

The following examples embodiments are merely illustrative, and do not limit this disclosure in any way.

The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

### Example 1: The Utility Cart of FIGS. 1-4

A utility cart according to one example embodiment of the present disclosure is illustrated in FIGS. 1-4 and indicated generally by reference number 100. As shown in FIGS. 1-4, the utility cart 100 includes a cargo platform 102 having four wheels 104a-d, two electric motors 106a, b coupled to the cargo platform 102, and a rideable platform 108 configured to support a user (not shown). The electric motor 106a drives the wheel 104a and the electric motor 106b drives the wheel 104b, as explained above. For example, the electric motor 106a can drive (and thereby rotate) the wheel 104a while the wheel 104b is substantially stationary. This causes the utility cart 100 to turn about the wheel 104b (e.g., a pivot point) allowing the cart 100 to achieve a substantially zero radius turn. In other examples, both wheels 104a, 104b may be driven at the same time at the same speed or different speeds to move the utility cart 100 in a straight line or a curved line, as explained above.

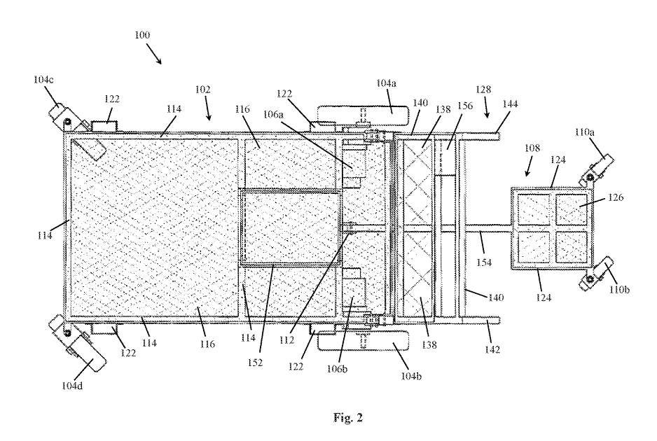

The cargo platform 102 of FIGS. 1-4 includes a frame 114 and a bed 116 coupled to the frame 114. The bed 116 may be coupled to the frame 114 via, for example, mechanical fasteners (e.g., screws, nuts, clamps, etc.). In other examples, the bed 116 may be welded to the frame 114. As shown best in FIGS. 1 and 2, the frame 114 includes various different structures coupled together. In the particular example of FIGS. 1-4, the frame 114 includes various one inch square steel tubes welded together. The bed 116 of FIGS. 1-4 includes a steel web like surface extending across the frame 114. This web like surface reduces the weight of the cargo platform 102 (and therefore the utility cart 100) compared to other carts having a solid platform. Alternatively, the frame 114 and/or the bed 116 may include other suitable structures formed of various different materials such as rigid plastic conduit (e.g., plastic tubing), solid frame structures, solid aluminum beds, etc.

As shown in FIGS. 1-4, the cargo platform 102 includes a battery compartment 118 positioned on the bottom side of the bed 116, and a door 152 substantially aligned with the battery compartment 118. The battery compartment 118 holds one or more rechargeable batteries 120 as explained above. Preferably, the shape and size of the battery compartment 118 substantially corresponds to the batteries 120 to save material, reduce weight, etc. The battery compartment 118 may be formed of solid walls (e.g., steel, aluminum, plastic, etc.), web like walls (e.g., steel, aluminum, plastic, etc.), etc.

As shown in FIG. 2, the door 152 is in its closed position. The door 152, however, can be opened to allow access to the batteries 120. In the particular example of FIGS. 1-4, the door 152 is pivotably coupled to the frame 114 via mechanical fasteners such as hinges, etc. In other examples, the door 152 can be removably coupled to the frame 114. Further, the door 152 may include a web like surface (e.g., similar to the bed 116), a solid plate, etc.

Additionally, the cargo platform 102 includes four tie downs 122 extending from the frame 114. In the particular example of FIGS. 1-4, the tie downs 122 are welded to the frame 114. The tie downs 122 allow a user to secure the cargo placed on the bed 116 via fasteners such as rope, bungee cords, straps, etc. Although the tie downs 122 are shown positioned near corners and along opposing edges of the cargo platform 102, it should be apparent that more or less tie downs 122 may be positioned along any side (e.g., bottom side, top side, edges, etc.) of the cargo platform 102 if desired.

As shown best in FIG. 1, the four wheels 104a-d of the cargo platform 102 are positioned adjacent respective corners of the cargo platform 102. This provides sufficient support and balance for the utility cart 100. In the particular example of FIGS. 1-4, the front wheels 104c, 104d are ten inch diameter pneumatic casters able to swivel as necessary. The rear wheels 104a, 104b are thirteen inch diameter pneumatic wheels. It should be apparent, however, that more or less wheels having different sizes, configurations, etc. may be employed if desired.

Similar to the cargo platform 102, the rideable platform 108 includes a frame 124 and a bed 126 coupled to the frame 124. The frame 124 and the bed 126 can support a user driving the utility cart 100. The frame 124 and the bed 126 may be substantially similar as or different than the frame 114 and the bed 116 of the cargo platform 102 explained above.

In the particular example of FIGS. 1-4, the rideable platform 108 is detachably coupled to the cargo platform 102. For example, the rideable platform 108 is detachably coupled to the cargo platform 102 via fastener(s) 112 (as explained above) and a structure 154 extending between the frame 124 of the rideable platform 108 and the frame 114 of the cargo platform 102. In the example of FIGS. 1-4, the structure 154 may be substantially similar to the structures of the frame 114, 124 (e.g., a one inch square steel tube, a rigid plastic conduit, etc.).

Additionally, and as shown best in FIGS. 2-4, the rideable platform 108 includes two wheels 110a, 110b positioned on opposing rear edges of the frame 124. In the particular example of FIGS. 1-4, the wheels 110a, 110b are six inch diameter pneumatic casters. It should be apparent that more or less wheels may be positioned along another suitable side (e.g., bottom side, edges, etc.) of the rideable platform 108 if desired. These wheels may be the same as or different than the wheels 110a, 110b.

As shown in FIGS. 1-4, the utility cart 100 further includes a handle bar 128 coupled to the cargo platform 102 via mechanical fasteners 130. In this particular example, the mechanical fasteners 130 include hinges and pins for pivotably coupling the handle bar 128 to the cargo platform 102. Thus, a user can manipulate the mechanical fasteners 130 (e.g., remove one or more pins) and fold the handle bar 128 onto the bed 116 of the cargo platform 102 for convenient storing of the utility cart 100.

Additionally, the mechanical fasteners 130 of FIGS. 1-4 may allow the handle bar 128 to detachably couple from the cargo platform 102. For example, a user can manipulate the mechanical fasteners 130 (e.g., remove one or more pins) and remove the handle bar 128 from the cargo platform 102 if desired. Alternatively, the mechanical fasteners 130 may be another suitable fastener that may or may not allow for removal, movement, etc. of the handle bar 128.

As shown best in FIG. 1, the handle bar 128 includes a mechanism to allow a user to adjust a length of the handle bar 128 if desired. In this particular example, the mechanism includes a slip sleeve adjustment mechanism. For example, the handle bar 128 includes two sets of tubes 132, 134 extending on opposing sides of the utility cart 100, and two mechanical fasteners 136 coupled to the sets of tubes 132, 134. The tube 134 has a larger inner perimeter than the outer perimeter of the tube 132. This allows the tube 134 (e.g., the outer tube) to slip over the tube 132 (e.g., the inner tube) and slide downwardly relative to the tube 132 which is coupled to the cargo platform 102 via the mechanical fasteners 130. Each mechanical fastener 136 includes a sleeve coupled to one of the tubes 132, 134 and one or more pins to allow the sleeve to detachably couple to the other tube 132, 134. As such, the length of the handle bar 128 can be adjusted by positioning (and repositioning if necessary) the pins after moving the tube 134 as explained above.

Additionally, the handle bar 128 includes a frame 140 and a plate 138 substantially similar to the frames 114, 124 and the beds 116, 126 of the cargo platform 102 and the rideable platform 108. The plate 138 may provide a support for cargo, a tie down location for cargo, protection for users on the rideable platform 108 against debris, etc. The frame 140 can include, for example, various one inch square steel tubes welded together and the plate 138 can include a steel web like surface, as explained above. Alternatively, the frame 140 and/or the plate 138 may include other suitable structures such as rigid plastic conduit, solid frame structures, solid aluminum plate, etc.

As shown in FIGS. 1-4, the frame 140 includes hand grip portions 142, 144 on opposing sides of the handle bar 128. The hand grip portions 142, 144 allow a user to securely grasp the handle bar 128 for stability while riding, pushing, etc. the utility cart 100. The hand grip portions 142, 144 may be formed of the same material as the frame 140 and/or may include a material to increase the user's grip (e.g., increase the friction between the user's hands and the hand grip portions 142, 144).

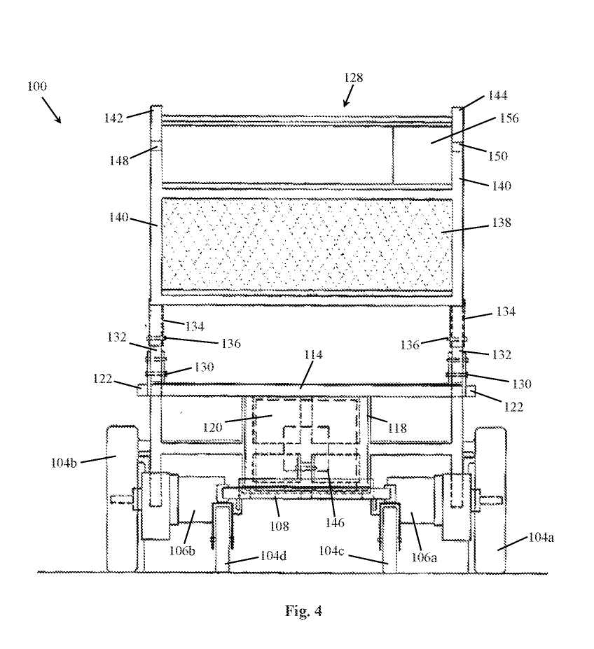

The utility cart 100 further includes a controller to control the electric motors 106a, 106b. For example, and as shown best in FIGS. 1 and 4, the utility cart 100 includes a control module 146 and actuating levers 148, 150 (e.g., user inputs) in communication with the control module 146. For example, the actuating levers 148, 150 provide one or more signals to the control module 146 which in turn provides appropriate control signals to the electric motors 106a, 106b as explained above. In the particular example of FIGS. 1-4, the actuating lever 148 controls the electric motor 106b via the control module 146 while the actuating lever 150 controls the electric motor 106a via the control module 146. This independent control of the motors provides various different benefits (e.g., substantially zero radius turning, etc.) as explained above.

The actuating levers 148, 150 are coupled to the frame 140 of the handle bar 128. More particularly, the actuating levers 148, 150 are coupled adjacent to the hand grip portions 142, 144, respectively. This allows a user to effectively control the electric motors 106a, 106b (and therefore the utility cart 100) while securely grasping the handle bar 128.

The control module 146 can include, for example, one or more control circuits such as an analog control circuit, a digital control circuit (e.g., a digital signal controller (DSC), a digital signal processor (DSP), etc.), or a hybrid control circuit (e.g., a digital control unit and an analog circuit). The control module 146 may be programmed (and reprogrammed) as desired.

Additionally and/or alternatively, the utility cart 100 can include other suitable user inputs, control module inputs, etc. as explained above. For example, one or both electric motors 106a, 106b may include a break lever and/or another suitable breaking device to stop the motors. In such examples, the utility cart 100 may include user inputs for activating the break levers and/or the other suitable breaking device. Additionally and/or alternatively, the electric motors 106a, 106b may be configured to allow the utility cart 100 to move in reverse. For example, a rotor of the electric motors 106a, 106b can rotate in a clockwise direction and a counter clockwise depending on the selection of one or more user inputs allowing the utility cart 100 to move forward and in reverse.

Further, and as shown best in FIGS. 2-4, the utility cart 100 may include a control panel 156 coupled to the frame 140 of the handle bar 128. The control panel 156 can include one or more user inputs (as explained above), indicators, etc. For example, the control panel 156 can include various switches to turn the electric motors 106a, 106b on/off, control the rotor's direction, control one or more lights on the utility cart 100, etc. Additionally and/or alternatively, the control panel 156 can include one or more battery life indicators, alarms indicating motor, battery, tire, etc. malfunctions and/or other suitable visual and/or audible indicators.

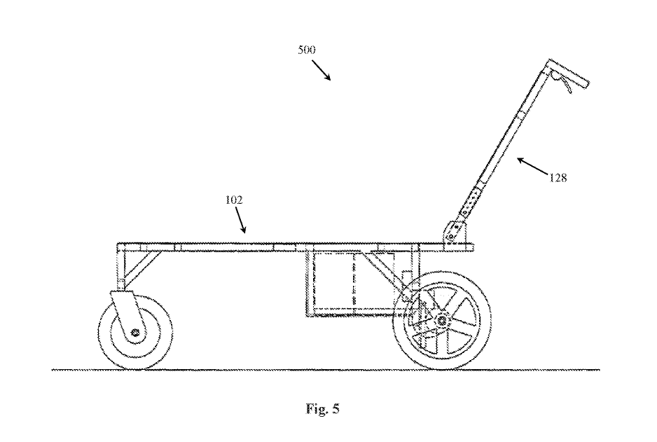

### Example 2: The Utility Cart of FIG. 5

FIG. 5 illustrates another example utility cart 500 substantially similar to the utility cart 100 of FIGS. 1-4, but with the rideable platform 108 detached. For example, the utility cart 500 includes the cargo platform 102 and the handle bar 128 of FIGS. 1-4. The utility cart 500, however, does not include a rideable platform coupled to the cargo platform 102.

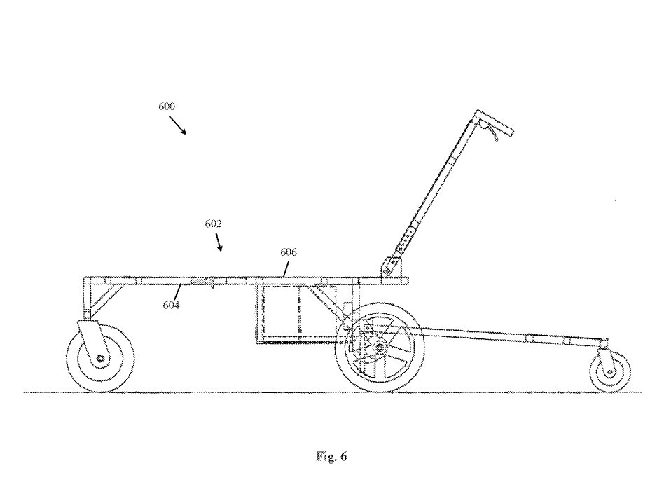

### Example 3: The Foldable Utility Cart of FIGS. 6-8

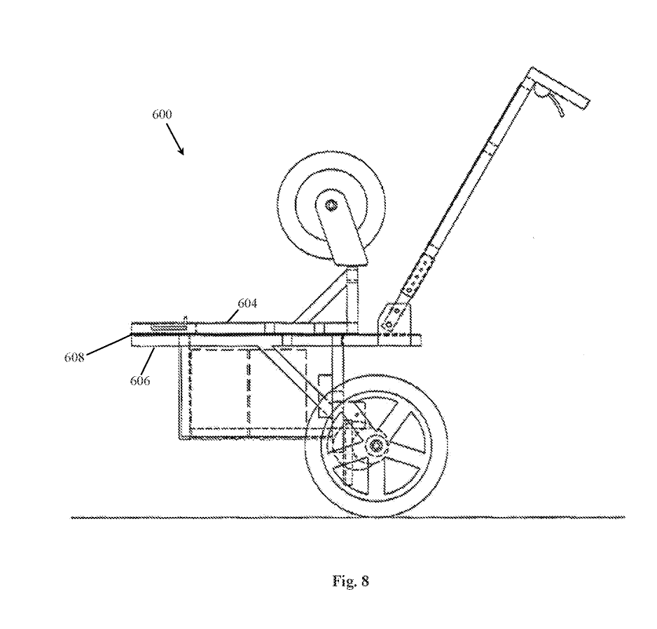

FIGS. 6-8 illustrate another example utility cart 600 substantially similar to the utility cart 100 of FIGS. 1-4, but including a foldable cargo platform. For example, the utility cart 600 includes a cargo platform 602 including platform portions 604, 606 and two joints 608 (e.g., hinges) coupled between the platform portions 604, 606. As shown in FIG. 8, the joints 608 allow the platform portion 604 to fold onto the platform portion 606. Additionally and/or alternatively, the joints 608 can allow the platform portion 606 to fold onto the platform portion 604 if desired.

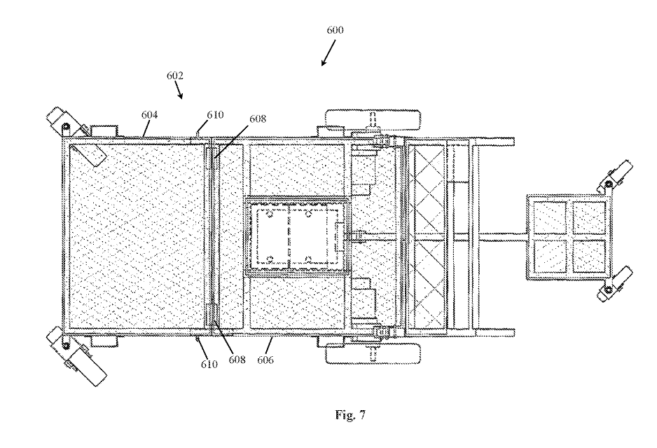

When the utility cart 600 is in its normal configuration (e.g., unfolded) as shown in FIGS. 6 and 7, the platform portions 604, 606 are substantially parallel to each other and in the same horizontal extending plane. In this position, the platform portions 604, 606 may be locked into place via slide bolt locking devices 610. For example, the slide bolt locking devices 610 may be coupled to a frame of one platform portion 604, 606. A user can then manipulate the locking devices 610 to slide a portion of the devices into a frame of the other platform portion 604, 606 thereby locking the platform portions 604, 606 in a substantially parallel position. To unlock the platform portions 604, 606, the user can manipulate the locking devices 610 to slide the portion of the devices out of the frame.

Additionally and/or alternatively, the cargo platform 602 can include substantially similar features as those described above relative to the cargo platform 102 of FIGS. 1-4.

The foregoing description of the example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A utility cart comprising:
a cargo platform including a plurality of wheels;
a plurality of electric motors coupled to the cargo platform, one of the plurality of electric motors corresponding to one of the plurality of wheels, another one of the plurality of electric motors corresponding to another one of the plurality of wheels, the plurality of electric motors configured to drive the plurality of wheels; and
a rideable platform configured to support a user, the rideable platform coupled to the cargo platform, the rideable platform including at least one wheel.

2. The utility cart of claim 1 wherein the rideable platform is detachably coupled to the cargo platform.

3. The utility cart of claim 1 wherein the cargo platform is a foldable cargo platform.

4. The utility cart of claim 1 wherein the cargo platform includes a first portion, a second portion, and one or more joints coupled between the first portion and the second portion, the joints configured to allow at least one of the first portion and the second portion to fold onto the other one of the first portion and the second portion.

5. The utility cart of claim 4 wherein the one or more joints include at least one hinge.

6. The utility cart of claim 1 wherein the at least two wheels of the rideable platform includes two wheels.

7. The utility cart of claim 1 wherein the at least two wheels of the cargo platform includes four wheels.

8. The utility cart of claim 1 wherein the plurality of electric motors includes two electric motors.

9. The utility cart of claim 8 wherein the two electric motors each include a direct drive electric motor.

10. The utility cart of claim 9 wherein each of the two electric motors is configured to drive its corresponding wheel of the plurality of wheels independently to allow for substantially zero radius turning of the utility cart.

11. The utility cart of claim 1 further comprising at least one handle bar coupled to the cargo platform.

12. The utility cart of claim 11 wherein the at least one handle bar includes a mechanism configured to adjust a length of the at least one handle bar.

13. The utility cart of claim 11 wherein the at least one handle bar is coupled to the cargo platform via one or more pivotable joints to allow the at least one handle bar to fold onto the cargo platform.

14. The utility cart of claim 1 further comprising a controller configured to control the plurality of electric motors.

15. The utility cart of claim 14 wherein the controller includes at least one control module coupled to the plurality of electric motors and one or more user operable inputs in communication with the at least one control module.

16. The utility cart of claim 15 further comprising at least one handle bar coupled to the cargo platform and wherein the one or more user operable inputs are coupled to the at least one handle bar.

17. The utility cart of claim 16 wherein the one or more user operable inputs includes one or more actuating levers.

18. The utility cart of claim 16 wherein the plurality of electric motors are each configured to receive electric power and wherein the one or more user operable inputs are configured to control an amount of electric power received by each of the plurality of electric motors.

19. The utility cart of claim 1 further comprising at least one battery configured to provide power to the plurality of electric motors.

20. The utility cart of claim 19 wherein the cargo platform includes a bed configured to support cargo and a battery compartment configured to support the at least one battery, wherein the bed includes a top side and a bottom side, and wherein the battery compartment is coupled to the bottom side of the bed.
